(19) United States
(12) Patent Application Publication
(10) Pub. No.: US 2009/0130406 A1
(43) Pub. Date: May 21, 2009

(54) BILLBOARD

(75) Inventors: Ludwig Morasch, Monte Carlo (MC); Otmar Ohlinger, Scharding am Inn (AT)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Science in Motion GmbH & Co., KG, Rotkreuz (LU)

(21) Appl. No.: 12/093,030

(22) PCT Filed: Oct. 27, 2006
(86) PCT No.: PCT/AT2006/000443

§ 371 Date: Aug. 26, 2008

(30) Foreign Application Priority Data
Nov. 8, 2005 (AT) A 1816/2005

(51) Int. Cl. B32B 3/10

(52) U.S. Cl. 428/207

(57) ABSTRACT

A billboard having a self-supporting, non-combustible panel (1) which has a base layer for printing inks that cure under ultraviolet light. In order to obtain non-combustible billboards, it is proposed that the panel (1) be produced from fibre cement and provided with a directly applied acrylate coating (2), optionally containing colour pigments, as base layer for acrylic-based printing inks.

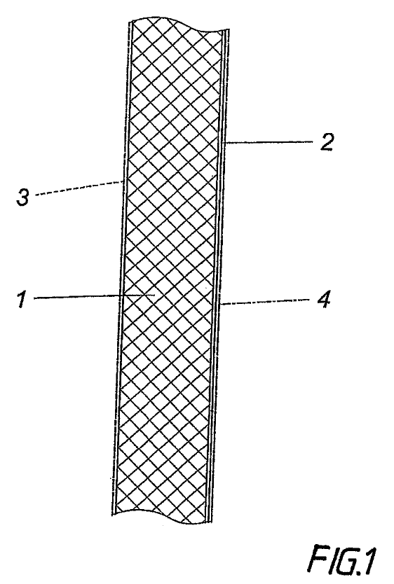

### TECHNICAL FIELD

The invention relates to a billboard having a self-supporting, non-combustible panel which has a base layer for printing inks that cure under ultraviolet light.

### PRIOR ART

Conventional billboards have a self-supporting panel, customarily made of a wood material, onto which posters are pasted. Such billboards have to be rated as combustible, however, and therefore may not be employed in spaces having a fire protection classification which prohibits the use of combustible fitments. That situation is not altered even when the self-supporting panel consists of a non-combustible material, for example metal or glass, because the printed film laminated onto the non-combustible panel, together with the layer of adhesive between the printed film and the non-combustible panel, produces a composite body which cannot be rated as non-combustible within the meaning of fire protection classifications. Apart from that, relatively large billboards having supporting panels of metal or glass are disadvantageous to building acoustics.

### DESCRIPTION OF THE INVENTION

The problem underlying the invention is accordingly to avoid those disadvantages and to construct a billboard of the kind described at the beginning so that the requirements in respect of non-combustibility can be fulfilled at comparatively low cost, without it being necessary to dispense with a highly detailed printed image.

The invention solves the problem posed by producing the panel from fibre cement and providing it with a directly applied acrylate coating, optionally containing colour pigments, as base layer for acrylic-based printing inks.

The use of fibre cement as material for the self-supporting panel first of all ensures advantageous building acoustic conditions, especially in the case of rear-ventilated mounting of the panels on a wall. In addition, such panels of fibre cement are moisture-resistant, which is especially important when billboards are arranged in damp spaces, such as is generally true of public car parks. In order that the non-combustibility of a billboard having such a self-supporting panel of fibre cement is not jeopardised by a laminated-on printed film of plastics or paper, such a film is dispensed with. Because, however, panels of fibre cement cannot be printed directly on account of the inadequate adhesion of the printing inks to the cement material, the visible side of the panel is provided with an acrylate coating which serves as base layer for the printing inks. The fact that acrylic-based printing inks that cure under ultraviolet light are used ensures a long-lasting, abrasion-resistant bond between the acrylate coating of the panel of fibre cement and the printing inks without additional binders, which represents an important prerequisite for such a billboard's being rated as non-combustible, although neither the acrylate coating nor the acrylic-based printing inks fulfil the fire protection criteria of non-combustibility per se. As a result of the base layer chosen, in co-operation with the printing inks matched thereto, however, the total thickness of the acrylate coating and the printing inks can be limited to an extent that allows the composite body of fibre cement and coating to be rated as non-combustible within the meaning of a fire protection classification. Since the supporting panel of fibre cement is provided with an acrylate coating, there is obtained an advantageous printing substrate for acrylic inks which, with the aid of a printer, can be sprayed directly onto the cleaned acrylate coating and cured with ultraviolet light, and, moreover, with a high degree of accuracy of detail of the printed image, which can have a photorealistic image quality. If desired, colour pigments can be added to the acrylate coating in order to provide a specific substrate colour.

In order that the billboard can be classified as non-combustible within the meaning of fire protection classifications, care should be taken that the total amount of the acrylate coating and the printing inks applied to the acrylate coating, based on a unit area of the panel, is less than the maximum amount permissible for the non-combustibility of the billboard. If the layer thicknesses of the acrylate coating and the printing inks are at most 0.1 mm in each case, those conditions can readily be fulfilled.

### BRIEF DESCRIPTION OF THE DRAWING

The drawing shows the subject of the invention by way of example, a detail of the billboard according to the invention being shown in cross-section.

### METHOD FOR IMPLEMENTING THE INVENTION

The billboard according to the exemplified embodiment has a self-supporting panel 1 made of fibre cement, which is provided on its visible side with an acrylate coating 2. The rear side can likewise have a coating 3 which must, however, be such that the non-combustibility of the composite body within the meaning of fire protection classifications is not in doubt. The acrylate coating 2, to which colour pigments have optionally been added, can be printed on directly, more specifically with the aid of a printer which sprays the printing inks digitally onto the acrylate coating 2 as base layer under the control of the printer. The ink layer 4 of acrylic inks sprayed onto the acrylate coating 2 is cured during the printing operation with the aid of radiators of ultraviolet light, a long-lasting bond between the ink layer 4 and the acrylate coating 2 being obtained, without the need to use additional binders. In so doing, the total thickness of the acrylate coating 2 and the acrylic-based ink layer 4 can be kept sufficiently thin for the composite body to be classified as non-combustible, although neither the acrylate coating 2 nor the ink layer 4 can be rated as non-combustible per se. In addition, the low layer thickness of the acrylate coating 2 and the ink layer 4 has scarcely any effect on the sound-insulating properties of the panel 1 of fibre cement, so that advantageous building acoustic conditions are obtained when such billboards are used, especially when such boards of large surface area are mounted with rear ventilation on walls. On account of the low coating thickness and the moisture resistance of the billboard, the risk of stress cracks and splintering, for example as a result of temperature-related stresses or deformation, can also be ruled out.

1. Billboard having a self-supporting, non-combustible panel which has a base layer for printing inks that cure under ultraviolet light, characterised in that the panel (1) has been produced from fibre cement and provided with a directly applied acrylate coating (2), optionally containing colour pigments, as base layer for acrylic-based printing inks.

2. Billboard according to claim 1, characterised in that the total amount of the acrylate coating (2) and the printing inks applied to the acrylate coating, based on a unit area of the panel (1), is less than the maximum amount permissible for the non-combustibility of the billboard.
